(19) United States
(12) Patent Application Publication
(10) Pub. No.: US 2007/0286362 A1
(43) Pub. Date: Dec. 13, 2007

(54) System and method for managing customer messages

(76) Inventors: Greg Coleson, Decatur, GA (US); Warren Blackwell, Stone Mountain, GA (US); Kurt Heim, Bend, OR (US)

Correspondence Address: MCNAIR LAW FIRM, P.A., P.O. BOX 10827, GREENVILLE, SC, 29603-0827, US

(21) Appl. No.: 11/726,870

(22) Filed: Mar. 23, 2007

Related U.S. Application Data
(60) Provisional application No. 60/785,164, filed on Mar. 23, 2006.

(51) Int. Cl. H04M 11/00

(52) U.S. Cl. 379/88.16

(57) ABSTRACT

A system and method for managing customer messages comprising a unification server having a unification server computer readable medium communicating with a customer communications system and a media server; a set of local pre-recorded customer messages embodied in the unification server computer readable medium; a computer readable unification instructions set embodied in the unification server computer readable medium for receiving a customer message update from the media server, updating a local pre-recorded customer message according to the customer message update, and sending a local pre-recorded customer message to the communications system so that the communications system can be updated with the customer message; a set of customer message updates embodied in a media server computer readable medium; and a computer readable media instructions set embodied in the media server computer readable medium for transmitting the customer message updates to the unification server and receiving status information from the unification server.

### CROSS-REFERENCE TO RELATED APPLICATION

This application claims priority on U.S. Provisional Patent Application Ser. No. 60/785,164 filed on Mar. 23, 2006 and entitled System and Method for Automated Updates to Message Delivery Systems incorporated herein.

### FIELD OF THE INVENTION

This invention is a system and method for automated updating of pre-recorded customer messages for customer communication systems.

### BACKGROUND OF THE INVENTION

Customer message systems include telephone systems that have voice, fax, and regular text messages. Additionally, customer message systems can include broadcast systems for making public announcements inside locations such as a retail establishment. The broadcast system can be incorporated in the telephone system allowing the user of the telephone handset to make a broadcast. Further, a customer message system can include a wired or wireless help system. When a help button is pressed in a particular location of the store, the help system can broadcast a request for assistance message through either the telephone system or the public broadcast system to notify the employees of a particular establishment, such as a retail establishment, that a customer is requiring help in a specific location. Further, each of these customer message systems can be incorporated with an e-mail server and an e-mail client to deliver messages and other communications through an e-mail system. Background music and on-hold music can be incorporated within these customer message systems which is broadcast or played when a customer is on hold or in the background of a retail establishment. Messages can also be used when a call is transferred, sent to a specific department, or other transaction or transfer of customer communications so that the customer is provided with marketing messages and other information when these events occur. For example, when a call is transferred to the service department, a message may be played for the customer such as: “For the month of March, ten percent off service on automobiles” can be played while the customer is being transferred from the main number to the service department.

In another example, an overhead message could be: “Today we are offering a special on [product name] which will be on sale through [date].” This message changes from time-to-time to reflect the varying “specials” or other information which the department store wishes to communicate to consumers in the store. Further, different messages can be broadcast at different times of the day.

A message delivery system can also handle automated attendant prompts. For example, when someone calls the store, the telephone system would have an automated attendant which would contain certain content that is configurable for that day. The automated attendant may say, “Welcome to [department store]. Today is [date]. Please select the extension from the following list for whom you wish to reach.”

Entities are also faced with challenges when the customer message system is installed in the same location. It is advantageous to have consistent messaging throughout each of the customer message systems, but typically these message systems are not integrated, compatible, or otherwise share data well. For example, the background message of the physical location is desirable to be consistent with the background of the telephone system. The transfer message used to transfer a caller to the service department is desirable to be consistent with a marketing message that may be played when the help system is used in the service department to allow customers to hear consistent messaging regardless of the communications system's source.

Each physical location can have a communications system such as a telephone system that is physically separate from other communication systems such as a help system since each physical location may necessarily have different message hardware.

With the distribution of these separate communication systems, there is a need for an integrated method for unifying each of these customer systems so that each physical location presents consistent customer messages.

Further, there is a need for a unification system which unifies the different communication systems of a location.

Further, there is a need for a centralized location for updating customer messages and sending updates to the various locations.

### SUMMARY OF THE INVENTION

A system for managing customer messages comprising a unification server having a unification server computer readable medium in communication with a customer communications system and a media server; a set of local pre-recorded customer messages embodied in said unification server computer readable medium; a computer readable unification instructions set embodied in said unification server computer readable medium for receiving a customer message update from said media server, updating said local pre-recorded customer messages for said customer communications system according to said customer message update, and sending said local pre-recorded customer messages to said customer communications system to update said local pre-recorder customer messages; a set of customer message updates embodied in a media server computer readable medium; and, a computer readable media instructions set embodied in said media server computer readable medium for transmitting said customer message updates to said unification server and receiving status information from said unification server in response to said customer message updates.

A system for managing customer messages comprising a unification server having a unification server computer readable medium; a set of local pre-recorded customer messages embodied in said unification computer readable medium; a first customer communications system in communications with said unification server; a second customer communications system in communications with said unification server; a computer readable unification instructions set embodied in said unification server computer readable medium for transmitting a local pre-recorded customer message to said first customer communications system and said second customer communications system so that said first and second customer communications systems can broadcast consistent customer messages.

A method for managing customer messages comprising providing a set of local pre-recorded customer messages embodied in a unification server computer readable medium; receiving a customer message update from a media server computer readable medium; updating said set of local pre-recorded customer messages according to said customer message update; transmitting to a first customer communications system at least one local pre-recorded customer messages from said set of local pre-recorded customer messages; and, transmitting to a second customer communications system at least one local pre-recorded customer message from said set of local pre-recorded customer messages.

A method for managing customer messages comprising providing a customer message update on a media server; transmitting said customer message update from said media server to a first unification server having a first unification server computer readable medium; updating a local pre-recorded customer message embodied in said first unification server computer readable medium; transmitting said updated local pre-recorded customer message to a first customer communications system from said first unification server; transmitting said customer message update from said media server to a second unification server having a second unification computer readable medium; updating a local pre-recorded customer message embodied in said second unification server computer readable medium; and, transmitting said updated local pre-recorded customer message to a second customer communications system from said second unification server.

A system for managing customer messages comprising a media server having a media server computer readable medium; a customer message update embodied in said media server computer readable medium; a first unification server in communication with said media server and with a first customer communications system; a second unification server in communications with said media server and with a second customer communications system; and, a computer readable media instructions set embodied in said media server computer readable medium for transmitting said customer message update to said first unification server and transmitting said customer message update to said second unification server.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic of the present invention;

FIG. 2 is a flowchart of the present invention; and,

FIG. 3 is a data flow diagram of the present invention.

### DETAILED DESCRIPTION OF THE INVENTION

An object or module is a section of computer readable code embodied in a computer. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

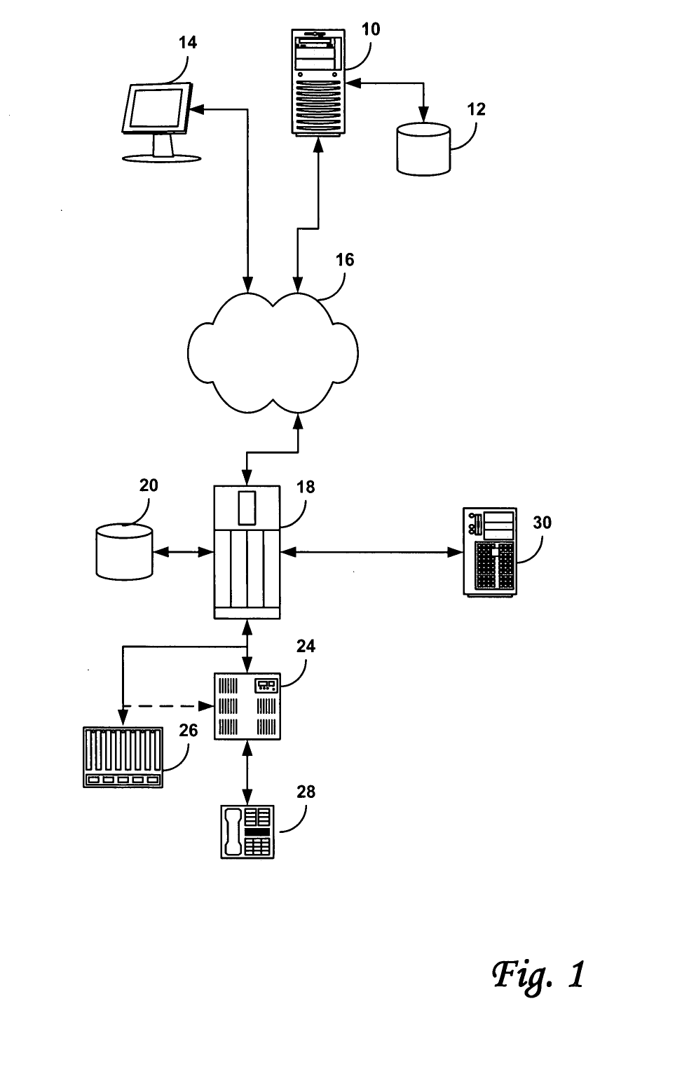

Referring now to FIG. 1, a media server 10 has media server computer readable medium 12. Terminal 14 is in communications with media server 10 through network 16. The media server can be accessed either directly from client 14 using a web browser or other terminal interface that serves as a portal to media server 10. Media server 10 can have a set of computer readable instructions for receiving updates to customer messages from a user and transmitting those updates to the unification server. The customer message updates can be stored in the media server computer readable medium until they are transmitted to the unification server.

Unification server 18 can have unification server computer readable media 20. The unification server can have several interfaces to allow communications with various communications systems. For example, the unification server can have an RCA audio output and can be connected to the hold port or the background music port of a telephone system. Therefore, the on-hold music and background music can be updated by the media server.

The unification server can also have analog parts and an SMDI interface to allow communication with a telephone system or PBX. The unification server can receive call information from the telephone system representing that a customer has called. The unification server can then process calls and broadcast customer messages to customers when customers call, are transferred to another extension, are on hold, leave a message or other caller function.

The unification server can also have a wireless interface for allowing communications with an in-store “help” system. When the customer presses the help button, a help request can be transmitted to the unification server, the unification server can access the overhead paging system and broadcast a pre-recorded customer message.

The unification server can also connect to an email system through a computer network. Customer messages can be sent to customers as well as managing email messages.

The unification server can be in connection with communications systems such as a PBX 24 which can operate telephone 28 as well as paging system 26. It should be noted that paging 26 can be in communications with PBX 24 or even integrated into the PBX. It should be noted that the paging system can also be a standalone system from the PBX or telephone system and can be in communications with the unification server. The unification server can have a set of computer readable unification instructions for receiving a customer message update from the media server. Each unification server can have a set of local pre-recorded customer messages embodied in the unification server computer readable medium. Examples of pre-recorded messages include “Head over to TV and video for specials on [brand]” for overhead paging; “For the month of June, service specials include a free carwash” for a telephone message played when someone is transferred to the service department; and “Help needed in the service department, 10% discount on service jobs over $500” for the in-house help system.

Local pre-recorded customer messages and therefore customer message updates can include scheduling information representing when the particular local pre-recorded customer message should be broadcast. For example, the message, “The store is closing in 10 minutes” could have scheduling information so that it plays at 8:50 p.m.

The unification server can have a set of computer readable unification instructions for updating the local pre-recorded customer messages according to the customer message update received from the media server. Therefore, the unification server can send the updated local pre-recorded customer message to the appropriate communication system such as the telephone system, paging system, or in-store help system.

Computer readable medium 12 and unification server 18 can therefore contain the content in the respective formats for the communication systems such as the automated attendant, voicemail system, e-mail server, overhead page announcer, hold music, background music, or promotional messaging to be broadcast through the department store. The unification server can also be in communications with e-mail system 30.

Since each communication system has a unique identifier, specific content can also be transmitted to each location allowing some customization of the messaging delivered to each store.

Therefore, the media server can contain customer message updates for each communication system and can transmit these updates to the unification server at any time. Additionally, the communication system or unification server can request customer message updates and the media server would then send customer updates in response to the request. Further, the unification server can be programmed to communicate with the media communications server and request updates at any time.

For example, the retail stores may have each unification server contact the media server nightly to receive any updates. If the updates are successful, the events can be logged by the media server so that there is a record of what unification server made communications with the media server and what updates were transmitted.

If there is an error in the process, an e-mail message can be sent to e-mail server 30 and can notify a user of the system allowing them to react or perform what tasks are necessary in response to the error.

It should also be noted that the unification server can also be in communication with an in-store help communications system for assistance. In retail stores, there are stations which have in-store “help” systems that, when actuated, can page for assistance to be directed to the particular location where the customer pressed the “help” button. These help buttons trigger an overhead page and contain content that directs the sales associate or other assisting employee to the customer's location. This content can also be updated through the media server as needed or requested and the update delivered to the message delivery system. These help buttons can also trigger a customer marketing message which is broadcast over the overhead page system when the button is pressed.

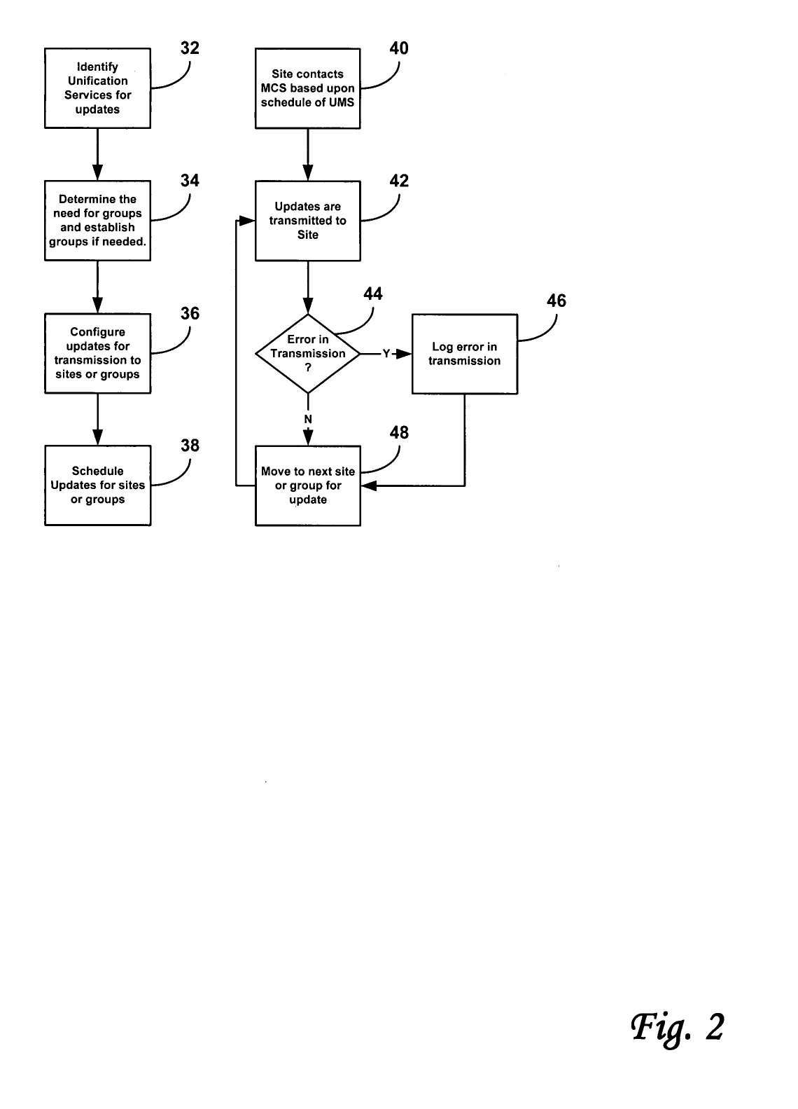

Referring now to FIG. 2, the process for updating the unification server by the media server is described in more detail. When using the console to access the media server, the unification servers to be updated are identified at 32. At step 34, the determination is made if groups are needed, and if so, groups of unification servers are established so that updates can occur to a group of unification servers without having to individually update each physical location.

At 36, the customer message updates are configured to be sent and a schedule for updates can be determined at 38. When configuring the updates, the customer message and date information can be organized into departments with opening and closing greetings and different .wav files or other audio files transmitted to the unification server to handle the various communications. For example, department 1 may have the car audio rebate message while department 2 may have a customer service message. This information is contained on the media server and therefore sent to the unification server for access by the communications systems. Once the media server has the schedule and the updates for sites or groups, then the site is contacted based upon an update at 40. Further, updates can be transmitted according to a response to an update request which is received from the unification server rather than have the media server send updates on some predetermined schedule.

A media server can send customer message updates to a unification server or to a plurality of unification servers. Unification servers can be arranged into groups so that the media server can send customer message updates to groups of unification servers. For example, there may be a Washington D.C. group which contains all the unification servers in Washington, D.C. A media server can then send customer message information to this group so that all the unification servers in Washington, D.C. receive the customer message update. The updates can be sent at pre-determined times based upon a set of update schedule information embodied in said media server computer readable medium. For example, east coast unification servers may receive customer update information at 2:00 a.m. EST while west coast unification servers would receive customer message updates at 5:00 a.m. EST (2:00 a.m. PST).

Updates are then transmitted to the unification server at step 42 and at step 44, a determination of whether there was an error in the transmission is made. If there is an error, the error is logged at 46 and the process moves to 48 so that the process can move to the next location to be updated. Further, updates can occur simultaneously for a plurality of unification servers.

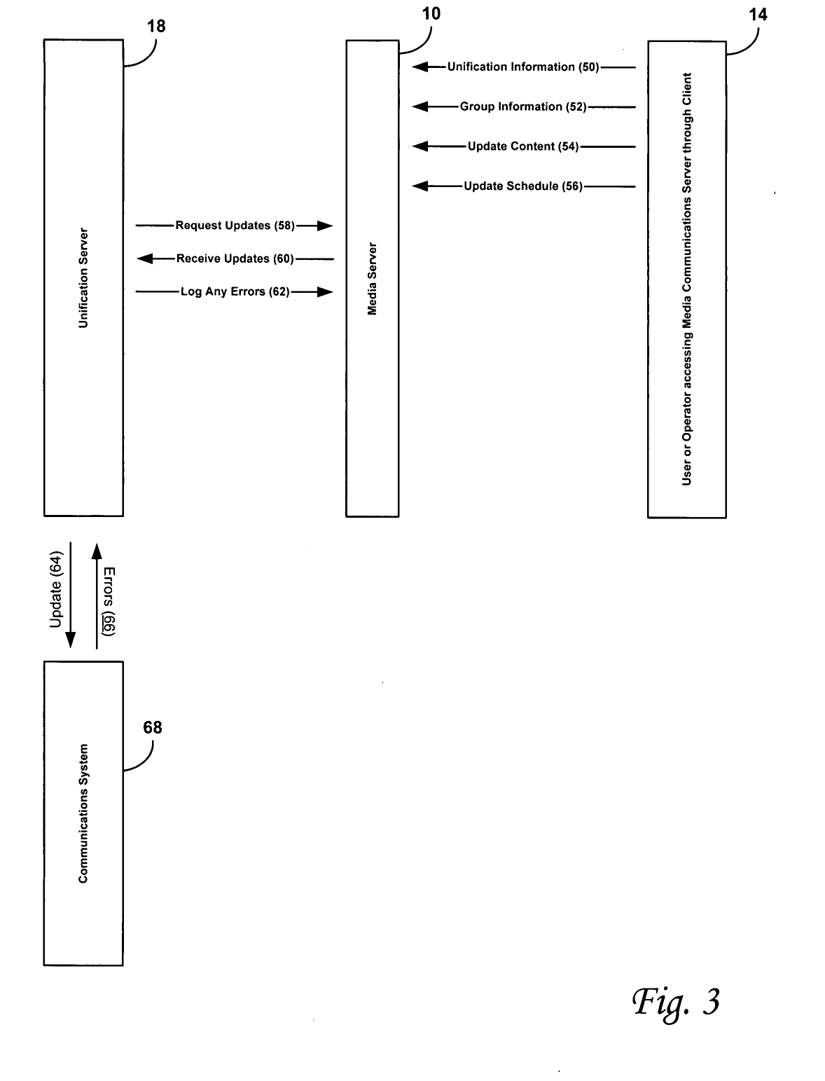

Referring now to FIG. 3, the data flow is illustrated. The client 14 can be used to provide the media server 10 with unification server information 50 such as customer message updates, group information representing unification servers at 52, the customer message updates at 54, and an update schedule for each unification server or group at 56. The unification server 18 requests updates at 58, receives the updates at 60, and logs any errors at 62. A communication system 68 can then receive an updated local pre-recorded customer message at 64 and return an error message if necessary at 66.

While a preferred embodiment of the invention has been described using specific terms, such description is for illustrative purposes only, and it is to be understood that changes and variations may be made without departing from the spirit or scope of the following claims.

What is claimed is:

1. A system for managing customer messages comprising:
a unification server having a unification server computer readable medium in communication with a customer communications system and a media server;
a set of local pre-recorded customer messages embodied in said unification server computer readable medium;
a computer readable unification instructions set embodied in said unification server computer readable medium for receiving a customer message update from said media server, updating said local pre-recorded customer messages for said customer communications system according to said customer message update, and sending said local pre-recorded customer messages to said customer communications system to update said local pre-recorder customer messages;
a set of customer message updates embodied in a media server computer readable medium; and,
a computer readable media instructions set embodied in said media server computer readable medium for transmitting said customer message updates to said unification server and receiving status information from said unification server in response to said customer message updates.

2. The system of claim 1 wherein:
said unification server computer readable medium is in communication with at least two customer communication systems selected from the group consisting of a telephone system, an overhead paging system, an in-store help request system and an email system; and,
said computer readable unification instructions set include instructions for sending at least one of said local pre-recorded customer messages to each of said customer communication systems in communications with said unification server.

3. The system of claim 1 including:
a set of location information embodied in said media server computer readable medium representing a plurality of unification servers; and,
said computer readable media instructions set including instructions for sending customer message updates to unification servers according to said set of location information so that multiple unification servers can be updated with said customer message updates.

4. The system of claim 3 wherein said computer readable media instructions set includes instructions for organizing said set of location information into groups so that a group of unification servers can be updated with said customer message updates.

5. The system of claim 1 including:
a set of update schedule information embodied in said media server computer readable medium; and,
said computer readable media instructions set including instructions for transmitting said customer message update to said unification server according to said update schedule information so that updates can be sent to said unification server at pre-determined times.

6. The system of claim 1 including:
an in-store help system in communication with said unification server; and,
said computer readable unification instructions set including instructions for receiving a help request from said in-store help system and transmitting said local pre-recorded customer messages to a paging system for broadcast.

7. The system of claim 1 including:
a telephone system in communication with said unification server; and,
said computer readable unification instructions set including instructions for receiving call information from said telephone system representing that a customer has called and transmitting a local pre-recorded customer message to said telephone system for broadcast to the customer caller while the telephone call is being processed.

8. A system for managing customer messages comprising:
a unification server having a unification server computer readable medium;
a set of local pre-recorded customer messages embodied in said unification computer readable medium;
a first customer communications system in communications with said unification server;
a second customer communications system in communications with said unification server;
a computer readable unification instructions set embodied in said unification server computer readable medium for transmitting a local pre-recorded customer message to said first customer communications system and said second customer communications system so that said first and second customer communications systems can broadcast consistent customer messages.

9. The system of claim 8 including:
a media server having a media server computer readable medium communicating with said unification server;
a customer message update embodied in said media server computer readable medium;
a computer readable media instructions set embodied in said media server computer readable medium for transmitting said customer message update to said unification server; and,
said computer readable unification instructions set including instructions for updating said set of local pre-recorded customer messages according to said customer message update.

10. The system of claim 9 including:
a plurality of unification servers each being in connection with a first and a second customer communications system; and,
said computer readable media instructions set including instructions for transmitting said customer message update to each of said plurality of unification servers.

11. The system of claim 10 including:
a plurality of unification servers each being in connection with a first and a second customer communications system;
a set of location information embodied in said media server computer readable medium representing each of said unification servers; and,
said computer readable media instructions set including instructions for transmitting said customer message update to said unification servers according to said set of location information.

12. The system of claim 11 wherein said computer readable media instructions set include instructions for organizing said set of location information into groups so that a group of unification servers can receive said customer message update.

13. The system of claim 11 wherein said computer readable media instructions set include instructions for update schedule information representing when said customer message update should be transmitted to said unification server.

14. The system of claim 9 wherein said customer message update includes scheduling information representing when to broadcast said customer message.

15. The system of claim 9 wherein said computer readable unification instructions set include instructions for determining if said customer message update should be transmitted from said media server.

16. The system of claim 8 including:
an in-store help system in communication with said unification server; and,
said computer readable unification instructions set including instructions for receiving a help request from said in-store help system and transmitting a local pre-recorded customer message to a paging system for broadcast.

17. The system of claim 8 including:
a telephone system in communication with said unification server; and,
said computer readable unification instructions set including instructions for receiving call information from said telephone system representing that a customer has called and transmitting a local pre-recorded customer message to said telephone system for broadcast to the customer caller while the telephone call is being processed.

18. A method for managing customer messages comprising:
providing a set of local pre-recorded customer messages embodied in a unification server computer readable medium;
receiving a customer message update from a media server computer readable medium;
updating said set of local pre-recorded customer messages according to said customer message update;
transmitting to a first customer communications system at least one local pre-recorded customer messages from said set of local pre-recorded customer messages; and,
transmitting to a second customer communications system at least one local pre-recorded customer message from said set of local pre-recorded customer messages.

19. The method of claim 18 wherein said step of transmitting to a first customer communications system at least one local pre-recorded customer message occurs according to update schedule information embodied in said unification server computer readable medium so that said transmission occurs at a predetermined time.

20. The method of claim 18 including:
receiving a help request from said first customer communications system; and,
broadcasting said local pre-recorded customer message in response to receiving said help request via said second customer communications system.

21. The method of claim 18 including:
receiving call information from said first customer communication system; and,
transmitting said local pre-recorded customer message to said first customer communications system in response to receiving said call information so that said local pre-recorded customer message can be broadcast to a caller.

22. A method for managing customer messages comprising:
providing a customer message update on a media server;
transmitting said customer message update from said media server to a first unification server having a first unification server computer readable medium;
updating a local pre-recorded customer message embodied in said first unification server computer readable medium;
transmitting said updated local pre-recorded customer message to a first customer communications system from said first unification server;
transmitting said customer message update from said media server to a second unification server having a second unification computer readable medium;
updating a local pre-recorded customer message embodied in said second unification server computer readable medium; and,
transmitting said updated local pre-recorded customer message to a second customer communications system from said second unification server.

23. The method of claim 22 including transmitting said customer message update from said media server to a third customer communications system from said first unification server.

24. The method of claim 22 including transmitting said customer message update from said media server to said second unification server according to schedule information representing when said customer message update should be transmitted to said second unification server.

25. The method of claim 22 including determining if said customer message update should be transmitted to said second unification server.

26. A system for managing customer messages comprising:
a media server having a media server computer readable medium;
a customer message update embodied in said media server computer readable medium;
a first unification server in communication with said media server and with a first customer communications system;
a second unification server in communications with said media server and with a second customer communications system; and,
a computer readable media instructions set embodied in said media server computer readable medium for transmitting said customer message update to said first unification server and transmitting said customer message update to said second unification server.

27. The system of claim 26 including:
a third customer communications system in communication with said first unification server; and,
said computer readable media instructions set including instructions for transmitting said customer message update to said third unification server.

28. The system of claim 26 including:
schedule information embodied in said media server computer readable medium; and,
said computer readable media instructions set including instructions for transmitting said customer message update to said second unification server according to schedule information representing when said customer message update should be transmitted to said second unification server.

29. The system of claim 26 wherein said computer readable media instructions set includes instructions for determining if said customer message update should be transmitted to said second unification server.
